(19) United States
(12) Patent Application Publication
(10) Pub. No.: US 2013/0292457 A1
(43) Pub. Date: Nov. 7, 2013

(54) SOLDER SHEET AND SMOLDERING METHOD USING THE SAME

(71) Applicants: Hyun Jung Lee, Gyunggi-do (KR); Young Ju Lee, Gyunggi-do (KR); Yun Bog Kim, Gyunggi-do (KR); Seon Young Myoung, Gyunggi-do (KR); Suk Jin Ham, Gyunggi-do (KR); Seong Chan Park, Gyunggi-do (KR)

(72) Inventors: Hyun Jung Lee, Gyunggi-do (KR); Young Ju Lee, Gyunggi-do (KR); Yun Bog Kim, Gyunggi-do (KR); Seon Young Myoung, Gyunggi-do (KR); Suk Jin Ham, Gyunggi-do (KR); Seong Chan Park, Gyunggi-do (KR)

(73) Assignee: SAMSUNG ELECTRO-MECHANICS CO., LTD., Gyunggi-do (KR)

(21) Appl. No.: 13/554,006

(22) Filed: Jul. 20, 2012

(30) Foreign Application Priority Data
May 3, 2012 (KR) 10-2012-0046947

(51) Int. Cl. B23K 35/02; B23K 1/00

(52) U.S. Cl. 228/245; 428/119

(57) ABSTRACT

Disclosed herein are a solder sheet and a soldering method using the same. The solder sheet includes: a plurality of solder rods arranged to have a uniform height h and an area density N; and a support having an adhesive formed on one surface thereof and supporting the plurality of solder rods such that one end of each of the plurality of solder rods is attached to be perpendicular to the surface on which the adhesive is formed. Solder bumps can be formed on soldering portions of the substrate by using the solder sheet through a single process without a mask, and thus, the process can be simplified, costs can be reduced, and a defect rate can be lowered, thereby enhancing reliability.

### CROSS REFERENCE TO RELATED APPLICATION

This application claims the benefit of Korean Patent Application No. 10-2012-0046947, filed on May 3, 2012, entitled “Solder Sheet and Soldering Using the Same”, which is hereby incorporated by reference in its entirety into this application.

### BACKGROUND OF THE INVENTION

1. Technical Field

The present invention relates to a solder sheet and a soldering method using the same.

2. Description of the Related Art

As electronic devices tend to be reduced in size and have high density, electronic packaging is advancing toward the use of solder bumps, rather than using a lead frame in the past.

Recently, a solder pre-coating method in which bumps are formed on a soldering portion of a substrate beforehand is commonly used, solder pre-coating may be obtained through, for example, a plating method, a hot leveling method, a solder pasting method, a solder ball method, a powder sheet method, or the like.

As for the plating method, types of plating solutions are restricted, so there is a limitation in forming solder bumps. Also, it is difficult to form bumps by an amount required for soldering portions of a substrate. In the case of the hot leveling method, the amount of solder can be adjusted by adjusting hot air, but there is a significant deviation in the amounts of bumps as formed.

In the solder pasting method, a solder paste is applied to soldering portions of a substrate by using a mask, the mask is removed, and then, the substrate is heated to melt the solder paste to form solder.

However, in this method, if the soldering portions of the substrate are small, it is very difficult to make the soldering portions and holes of the mask conformed to each other, having a possibility that solder paste will not be applied to the soldering portions, and additional problems arise in that it is difficult to fill the solder paste into small holes of the mask and, after the small holes of the mask are filled with the solder paste, the solder paste cannot be readily applied to the soldering portions.

In addition, the solder ball method disclosed in U.S. Pat. No. 6,413,850 is a method of obtaining solder bumps by mounting solder balls on soldering portions of a substrate by using a certain mask or a suction jig, and then, melting the solder balls.

With this method, since solder balls having a regular size are used, the amount of formed solder bumps are uniform, but the solder balls can be applied only to circular soldering portions. In addition, when solder balls are adsorbed (or sucked) by the suction jig, a plurality of solder balls may be adsorbed into a single hole due to static electricity, or solder balls may be blown away, rather than being mounted on the soldering portions, by air jetted out when the solder balls are mounted on the soldering portions of the substrate. It is not easy or impossible to apply the solder ball method to soldering portions having a small size, having a high defect rate.

Referring to the powder sheet method, a layer of solder balls are provided, having a problem in which a required amount of solder bumps cannot be formed through a single process. Thus, in order to adjust the shape of the bumps formed on corresponding soldering portions or form bumps having a desired size, a process of applying a flux to the soldering portions, heating solder balls at a melting temperature or higher, and then, cooling the same should be repeatedly performed.

The repeated process causes temporal and unnecessary economical consumption and, during a solder ball attachment process of additionally forming an oxide layer or a flux component on the surface of solder bumps after a single soldering process, the solder balls may not adhere or pores may be formed within solder bumps, which causes a defect. Also, the substrate is affected by the repeated performing of heating and cooling processes, so reliability thereof may be degraded.

### PRIOR ART DOCUMENT

### Patent Document

(Patent Document 1) U.S. Pat. No. 6,413,850

### SUMMARY OF THE INVENTION

The present invention has been made in an effort to provide a solder sheet on which a plurality of solder rods having a pillar shape are arranged to allow the amount of solders to be formed to be adjusted according to the shape and size of soldering portions of a substrate.

The present invention has also been made in an effort to provide a method of forming a required amount of solder bumps having a desired shape on relevant soldering portions and performing soldering through a single process by using the solder sheet without a mask.

According to a first preferred embodiment of the present invention, there is provided a solder sheet including: a plurality of solder rods arranged to have a uniform height h and an area density N; and a support having an adhesive formed on one surface thereof and supporting the plurality of solder rods such that one end of each of the plurality of solder rods is attached (or bonded) to be perpendicular to the surface on which the adhesive is formed.

The plurality of solder rods may be any one of circular pillars and polygonal pillars.

The area density N of the plurality of solder rods may satisfy Conditional Expression 1 according to the size of solder bumps formed as the plurality of solder rods are melted on soldering portions of a substrate.

$$\frac{π R {1}^{2}}{4 {( R 1 + R 2 )}^{2}} \leq N \leq 1 \qquad [ Conditional Expression 1 ]$$

wherein R1 is a diameter of the soldering portions and R2 is a distance between the soldering portions.

A height h of the plurality of solder rods may satisfy Conditional Expression 2 according to the size of solder bumps formed as the plurality of solder rods are melted on soldering portions of a substrate.

$$H \leq h \leq \frac{4 {( R 1 + R 2 )}^{2}}{π R {1}^{2}} \qquad [ Conditional Expression 2 ]$$

wherein R1 is a diameter of the soldering portions, R2 is a distance between the soldering portions, and H is a height of the solder bumps.

The support may be made of any one of a metal, a polymer material, ceramic, carbon composites, or a mixture thereof, having heat resistance and pressure resistance.

The adhesive may be any one of a film type adhesive and a paste type adhesive.

According to a second preferred embodiment of the present invention, there is provided a soldering method using a solder sheet, including: (A) forming a solder sheet by arranging a plurality of solder rods on an adhesive support; (B) placing the solder sheet on a substrate with soldering portions formed thereon, pressurizing the solder sheet and the substrate, and then, heating the same; (C) when the plurality of solder rods of the heated solder sheet are melted on the soldering portions of the substrate, cooling the solder rods to form solder bumps on the soldering portions; and (D) removing the support.

Step (A) may include: (A1) forming an adhesive on one surface of the support; and (A2) arranging and then pressing the plurality of solder rods such that one end of each of the plurality of solder rods is attached to be perpendicular to the adhesive.

In step (A1), a film type adhesive may be attached to one surface of the support, and in step (A1), a paste type adhesive may be attached to one surface of the support.

Step (A2) may include: (A2-1) attaching an aligner to the adhesive; (A2-2) filling the aligner with the plurality of solder rods and arranging the plurality of solder rods such that one end of each of the plurality of solder rods is perpendicular to the adhesive; and (A2-3) pressurizing both ends of the plurality of solder rods such that the plurality of arranged solder rods are attached to the adhesive.

Step (B) may include: (B1) placing the solder sheet on the substrate such that the plurality of solder rods are laid on the soldering portions of the substrate; (B2) pressurizing the solder sheet and the substrate in an overlapping state; and (B3) heating the pressurized solder sheet and substrate at a melting temperature of the plurality of solder rods, or higher.

The method may further include: (B4) applying a flux to the substrate, before step (B1).

Step (C) may include: (C1) melting the plurality of solder rods of the heated solder sheet on the soldering portions of the substrate; and (C2) cooling the melted solder rods to form solder bumps on the soldering portions.

The method may further include: (E) removing remaining solder bumps other than those formed on the soldering portions of the substrate, after step (D).

In step (E), any one of an air blowing process and a cleansing process may be performed.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are perspective views of a solder sheet according to a an embodiment of the present invention;

FIGS. 2A and 2B are perspective views of an aligner used to arrange a plurality of solder rods illustrated in FIGS. 1A and 1B;

FIGS. 3A and 3B are views showing the plurality of solder rods when they are filled and arranged by the aligner illustrated in FIGS. 2A and 2B;

FIG. 4 is a view illustrating the attachment of the plurality of solder rods arranged by the aligner illustrated in FIGS. 3A and 3B to a support;

FIGS. 5A through 5D are views illustrating a soldering method using a solder sheet according to an embodiment of the present invention; and

FIGS. 6A and 6B are partially detailed views illustrating a height and an area density of a solder rod according to a size of soldering portions and solder bumps illustrated in FIG. 5D.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

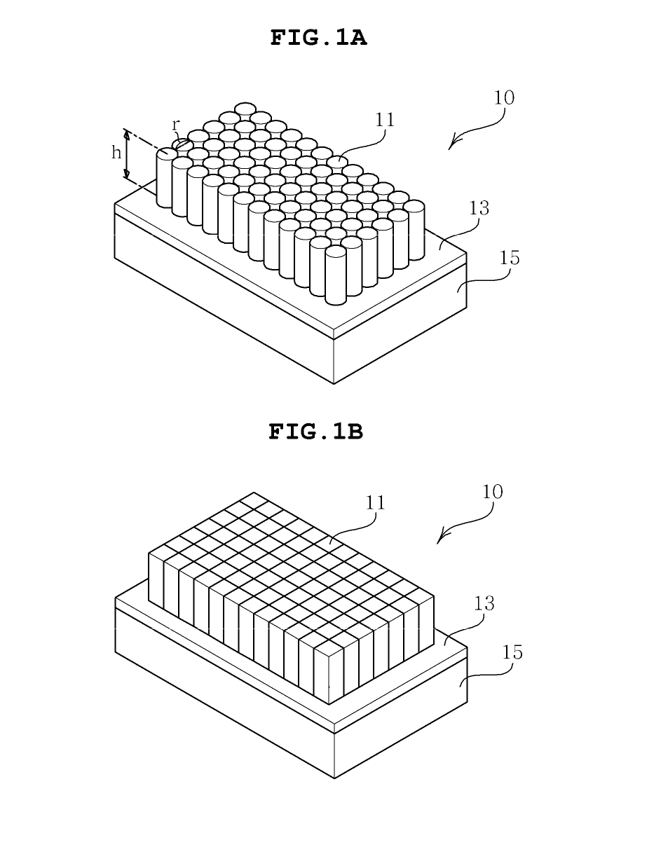

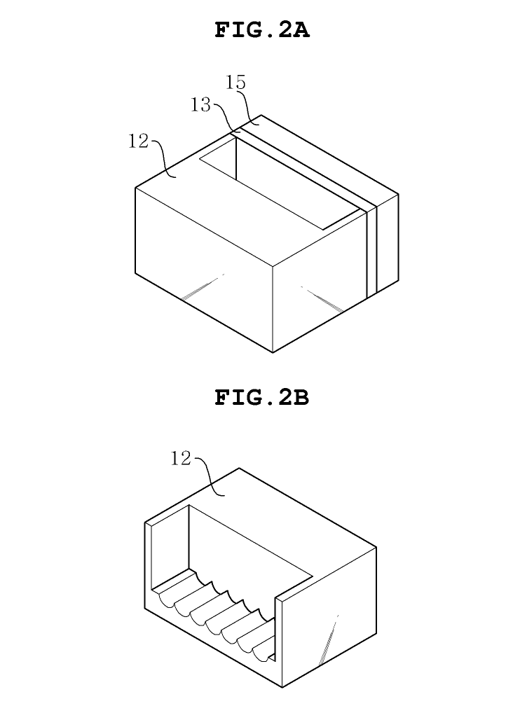

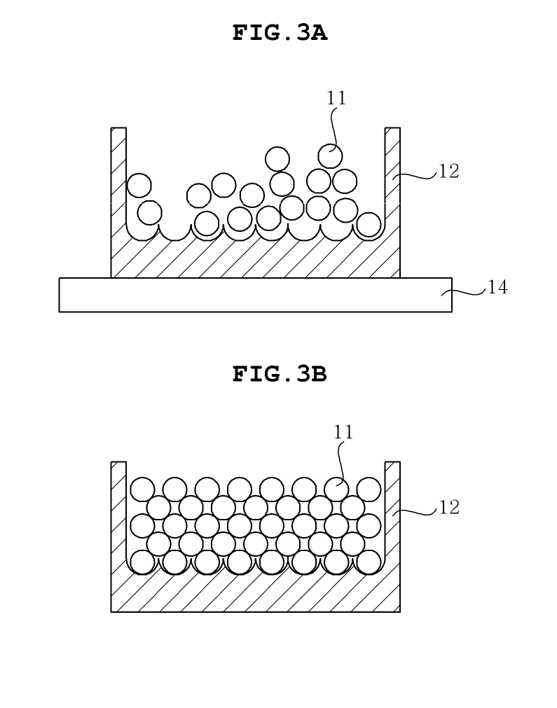

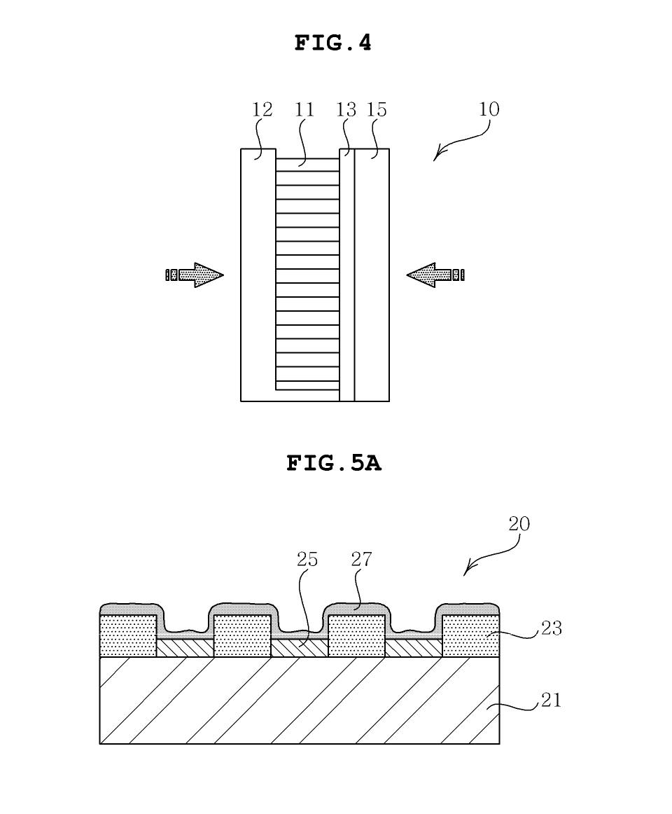

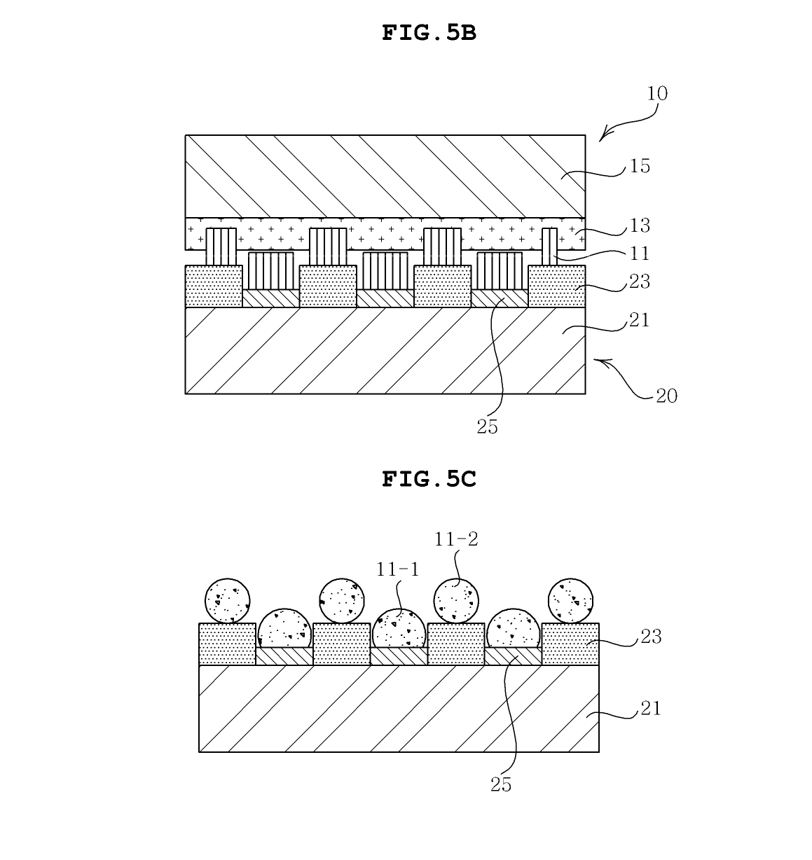

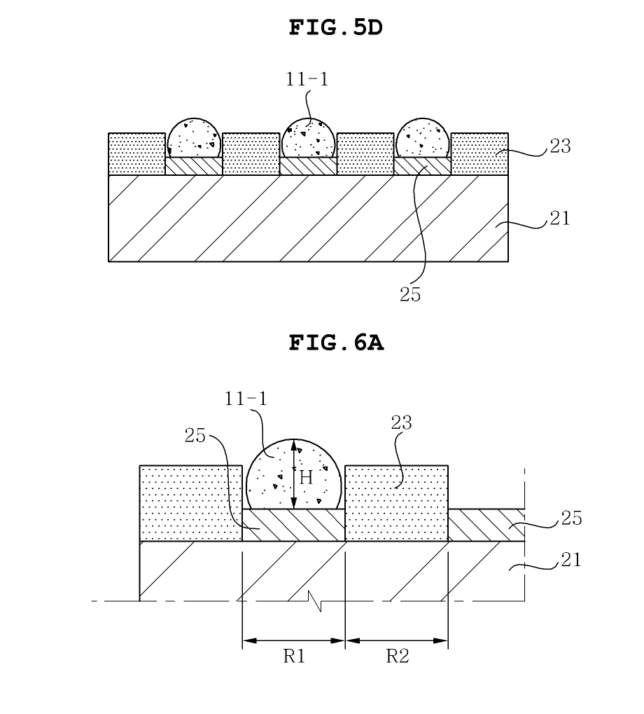

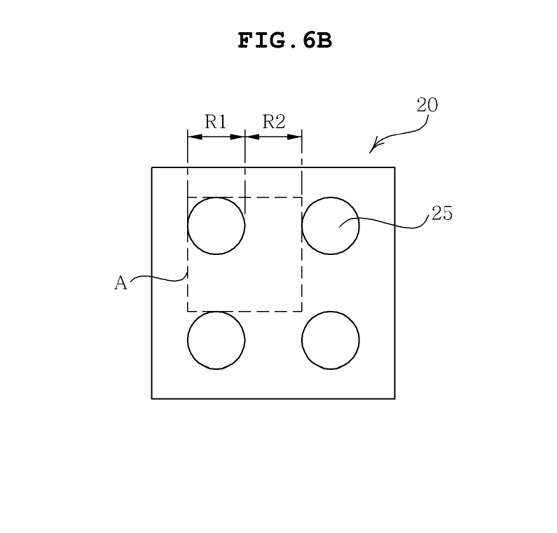

FIGS. 1A and 1B are perspective views of a solder sheet according to an embodiment of the present invention. FIGS. 2A and 2B are perspective views of an aligner used to arrange a plurality of solder rods illustrated in FIGS. 1A and 1B. FIGS. 3A and 3B are views showing the plurality of solder rods when they are filled and arranged by the aligner illustrated in FIGS. 2A and 2B. FIG. 4 is a view illustrating the attachment of the plurality of solder rods arranged by the aligner illustrated in FIGS. 3A and 3B to a support; FIGS. 5A through 5D are views illustrating a soldering method using a solder sheet according to an embodiment of the present invention. FIGS. 6A and 6B are partially detailed views illustrating a height and an area density of solder rods according to a size of soldering portions of the substrate and solder bumps.

With reference to FIGS. 1A and 1B, a solder sheet 10 according to an embodiment of the present invention includes a plurality of solder rods 11 arranged to have a uniform height h and an area density N and a support 15 having an adhesive 13 formed on one surface thereof and supporting the plurality of solder rods 11 such that one end of each of the plurality of solder rods 11 is attached to be perpendicular to the surface on which the adhesive 13 is formed.

Each of the plurality of solder rods 11 may have a pillar or rod shape with a circular or polygonal base plane and a certain height h. For example, the plurality of solder rods 11 may have a shape of a cylinder as shown in FIG. 1A or a polygonal pillar having various shapes including a hexahedron as shown in FIG. 1B.

The solder sheet 10 is mounted on a substrate with soldering portions 25 formed thereon and the plurality of solder rods 11 are melted to form solder bumps 11-1 on the soldering portions 25 (See FIGS. 5A through 5D), and in this case, the height h and the area density N of the plurality of solder rods 11 may be adjusted according to the size of the solder bumps 11-1.

In other words, the height h of the plurality of solder rods 11 may be adjusted based on the size, e.g., a volume, a height, a diameter, or the like, of the solder bumps 11-1 desired to be formed on the soldering portions 25 of the substrate 20.

For example, as shown in FIGS. 6A and 6B, when the diameter of the soldering portion 25 of the substrate 20 is R1, an interval between the soldering portions 25 is R2, and a height of the solder bump 11-1 desired to be formed on the soldering portion 25 is H, the area density N and height h of the plurality of solder rods 11 may be adjusted to satisfy Conditional Expression 1 and Conditional Expression 2 shown below, respectively.

In detail, an area density n of the soldering portions 25 of the substrate 20 may be obtained by dividing the area of the soldering portions 25 by a valid area A of the substrate 20, so a maximum area density nₘₐₓ of the soldering portions 25 may be represented by Equation 1 shown below.

nₘₐₓ=π(R1/2)²/(R1+R2)² [Equation 1]

Here, a maximum area density for the plurality of solder rods 11 to be arranged is 1.

Also, the area density N of the plurality of solder rods 11 should be greater than or equal to the maximum area density nₘₐₓ of the soldering portions 25 of the substrate 20 to form the solder bumps 11-1 on all the soldering portions 25.

Thus, the area density N of the plurality of solder rods 11 may be adjusted to satisfy Conditional Expression 1 shown below.

$$\frac{π R {1}^{2}}{4 {( R 1 + R 2 )}^{2}} \leq N \leq 1 \qquad [ Conditional Expression 1 ]$$

Meanwhile, the volume V of the solder bumps 11-1 may be represented by Equation 2 shown below.

$$V = {π ( \frac{R 1}{2} )}^{2} \times H \qquad [ Equation 2 ]$$

Also, the solder bumps 11-1 are formed by the plurality of solder rods 11, so the volume V of the solder bumps 11-1 may be represented by Equation 3 shown below.

$$V = {π ( \frac{R 1}{2} )}^{2} \times N \times h \qquad [ Equation 3 ]$$

Here, N is an area density of the plurality of solder rods 11, i.e., an area of the solder rods 11 per unit area.

Equation 4 shown below may be derived from Equation 2 and Equation 3.

Since

$$V = {π ( \frac{R 1}{2} )}^{2} \times H = {π ( \frac{R 1}{2} )}^{2} \times N \times h , \\ N \times h = H . \qquad [ Equation 4 ]$$

Thus, based on Equation 4 and Conditional Expression 1, the height h of the plurality of solder rods 11 may be adjusted to satisfy Conditions Expression 2 shown below.

$$H \leq h \leq \frac{4 {( R 1 + R 2 )}^{2}}{π R {1}^{2}} \qquad [ Conditional Expression 2 ]$$

The height h of the plurality of solder rods 11 may range, for example, from 1 μm to 500 μm.

As described above, in the solder sheet 10 according to an embodiment of the present invention, the amount of the solder bumps 11-1 may be adjusted according to the size of the solder bumps 11-1 desired to be formed on the substrate 20 by adjusting the height h or the area density N of the plurality of solder rods 11.

The support 15 with the adhesive 13 formed on one surface thereof supports the plurality of solder rods 11 arranged to have a certain height h and an area density N such that one end of each of the plurality of solder rods 11 is attached to be perpendicular to the surface on which the adhesive 13 is formed.

A film type adhesive may be attached to one surface of the support 15 or a paste type adhesive may be applied to one surface of the support 15 to form the adhesive for attaching one end of each of the plurality of solder rods 11.

After the predetermined adhesive is formed on the support 15, a predetermined pressure is applied to both ends of the plurality of solder rods 11 such that one end of each of the plurality of solder rods 11 is not separated from the adhesive.

Here, a predetermined pressure is uniformly applied to the support 15 and the plurality of solder rods 11 such that the plurality of solder rods 11 cannot be separated from the adhesive 13.

Thus, the support 15 may be made of any one of a metal, a polymer material, ceramic, carbon composites, or a mixture thereof, having pressure resistance and heat resistance so that the support 15 cannot be broken or damaged by the pressure or melted or damaged at a melting temperature of the plurality of solder rods 11.

For example, as the metal, a metal such as aluminum or stainless steel or an alloy comprising two or more types of elements may be used. Also, any one of various alloys such as aluminum, copper, molybdenum, tungsten, and duralumin may be used.

As the polymer material, any one of plastic, plastic that includes or does not include a filler, composites of plastic and ceramic, and a crystalline polymer may be used.

Meanwhile, in order to arrange the plurality of solder rods 11 on the support 15, a certain aligner 12 may be used.

The aligner 12 serves to arrange the plurality of solder rods 11 such that the solder rods 11 have a uniform height h and area density N. As shown in FIG. 2A, a surface of the aligner 12 in contact with the adhesive 13 of the support 15 is open to have an opening surface to fill the plurality of solder rods 11 in the aligner 12.

Also, as shown in FIG. 2B, recesses may be formed to correspond to the shape of the solder rods 11 to allow the respective solder rods 11 to be easily arranged one by one, and a height of the aligner 12 may be adjusted according to the height h of the plurality of solder rods 11 in use.

As shown in FIGS. 3A and 3B, the aligner 12 may be filled with the plurality of solder rods 11 such that the plurality of solder rods 11 are arranged therein.

Here, in order to fully arrange the plurality of solder rods 11, a vibrator 14 such as a sonicator installed beneath the aligner 12 may be used to vibrate it.

In order to prevent the plurality of solder rods 11 arranged in the aligner 12 from being detached from the adhesive 13 of the support 15, a certain pressure is applied to both ends of the solder rods 11 (e.g., the aligner 12 and the support 15) as shown in FIG. 4.

Thereafter, when the aligner 12 is removed, the solder sheet 10 in which the plurality of solder rods 11 are arranged to have the uniform height h and the area density N on the support 15 with the adhesive 13 attached thereon as shown in FIGS. 1A and 1B is formed.

Hereinafter, a soldering method using the foregoing solder sheet 10 will be described.

First, as shown in FIG. 5A, a flux 27 is applied to the certain substrate 20 on which a circuit including the soldering portions 25, the solder resist 23, and the like, formed on a lower frame 21.

Here, the flux 27 serves to allow the plurality of solder rods 11 to be readily attached to the soldering portions 25. Preferably, the flux 27 is applied only to the soldering portions 25, not to the other portions (e.g., the solder resist 23, or the like) excluding the soldering portions 25.

And then, as shown in FIG. 5B, the solder sheet 10 is placed in an overlap manner on the substrate 20 with the soldering portions 25 formed thereon, pressed, and then, heated.

In detail, the solder sheet 10 is laid such that the plurality of solder rods 11 are placed on the corresponding soldering portions 25 of the substrate 20, and then, the solder sheet 10 and the substrate 20 are pressurized to be compressed.

Thereafter, the pressurized solder sheet 10 and the substrate 20 are heated at a melting temperature of the plurality of solder rods 11 in use, or higher.

Then, the plurality of solder rods 11 of the heated solder sheet 10 are melted on the corresponding soldering portions 25 of the substrate 20 from the support 15.

When the plurality of solder rods 11 are all melted on the corresponding soldering portions 25 of the substrate 20 or when a required amount of solders are melted, the melted solder rods 11 are cooled to form the solder bumps 11-1 on the soldering portions 25 as shown in FIG. 5C. Thereafter, the support 15 is removed from the substrate 20.

At this time, although solder bumps 11-2 are formed on portions (e.g., the solder resist 23, or the like) other than the soldering portions 25 of the substrate 20, they are not attached to the substrate 20. Thus, in order to remove the solder bumps 11-2 remaining in the substrate 20, for example, any one of an air-blowing process and a cleansing process is performed.

Then, a required amount of solder bumps 11-1 having a desired shape are formed only on the soldering portions 25 of the substrate 20 as shown in FIG. 5D.

In this manner, the use of the solder sheet and the soldering method using the same according to an embodiment of the present invention can accurately form a required amount of solders having a desired shape through a single process without using a mask. Thus, the soldering process can be simplified and facilitated, and in addition, since there is no need to use existing equipment such as a mask or a suction jig required for forming the solder bumps, economical efficiency can be obtained.

Also, since an amount of relevant solder bumps can be adjusted according to the shape and size of the relevant soldering portions, an appropriate amount of solder bumps can be formed even on fine soldering portions, lowering a defect rate, and since a heating and cooling process is not performed several times, reliability of the substrate itself can also be enhanced.

According to the preferred embodiments of the present invention, since the solder sheet including a plurality of solder rods whose height and area density is adjusted according to the shape and size of the soldering portions of the substrate is used, solder bumps can be formed on the soldering portions of the substrate through a single process without a mask in performing soldering on the soldering portions, thus simplifying the process and reducing costs.

In particular, since an amount of corresponding solder bumps can be adjusted according to the shape and size of the corresponding soldering portions, the solder bumps can be applied to the soldering portions having a small size and a defect rate can be degraded. In addition, since a heating and cooling process is not performed several times, reliability of the substrate itself can also be enhanced.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A solder sheet comprising:
a plurality of solder rods arranged to have a uniform height h and an area density N; and
a support having an adhesive formed on one surface thereof and supporting the plurality of solder rods such that one end of each of the plurality of solder rods is attached to be perpendicular to the surface on which the adhesive is formed.

2. The solder sheet as set forth in claim 1, wherein the plurality of solder rods are any one of circular pillars and polygonal pillars.

3. The solder sheet as set forth in claim 1, wherein the area density N of the plurality of solder rods satisfies Conditional Expression 1 according to the size of solder bumps formed as the plurality of solder rods are melted on soldering portions of a substrate.
$$\frac{π R {1}^{2}}{4 {( R 1 + R 2 )}^{2}} \leq N \leq 1 \qquad [ Conditional Expression 1 ]$$
wherein R1 is a diameter of the soldering portions and R2 is a distance between the soldering portions.

4. The solder sheet as set forth in claim 1, wherein a height h of the plurality of solder rods satisfies Conditional Expression 2 according to the size of solder bumps formed as the plurality of solder rods are melted on soldering portions of a substrate.
$$H \leq h \leq \frac{4 {( R 1 + R 2 )}^{2}}{π R {1}^{2}} \qquad [ Conditional Expression 2 ]$$
wherein R1 is a diameter of the soldering portions, R2 is a distance between the soldering portions, and H is a height of the solder bumps.

5. The solder sheet as set forth in claim 1, wherein the support is made of any one of a metal, a polymer material, ceramic, carbon composites, or a mixture thereof, having heat resistance and pressure resistance.

6. The solder sheet as set forth in claim 1, wherein the adhesive is any one of a film type adhesive and a paste type adhesive.

7. A soldering method using a solder sheet, the method comprising:
(A) forming a solder sheet by arranging a plurality of solder rods on an adhesive support;
(B) placing the solder sheet on a substrate with soldering portions formed thereon, pressurizing the solder sheet and the substrate, and then, heating the same;
(C) when the plurality of solder rods of the heated solder sheet are melted on the melting portions of the substrate, cooling the solder rods to form solder bumps on the soldering portions; and
(D) removing the support.

8. The method as set forth in claim 7, wherein step (A) includes:
(A1) forming an adhesive on one surface of the support; and
(A2) arranging and then pressing the plurality of solder rods such that one end of each of the plurality of solder rods is attached to be perpendicular to the adhesive.

9. The method as set forth in claim 8, wherein, in step (A1), a film type adhesive is attached to one surface of the support.

10. The method as set forth in claim 8, wherein, in step (A1), a paste type adhesive is attached to one surface of the support.

11. The method as set forth in claim 8, wherein step (A2) includes:
(A2-1) attaching an aligner to the adhesive;
(A2-2) filling the aligner with the plurality of solder rods and arranging the plurality of solder rods such that one end of each of the plurality of solder rods is perpendicular to the adhesive; and
(A2-3) pressurizing both ends of the plurality of solder rods such that the plurality of arranged solder rods are attached to the adhesive.

12. The method as set forth in claim 7, wherein step (B) includes:
(B1) placing the solder sheet on the substrate such that the plurality of solder rods are laid on the soldering portions of the substrate;
(B2) pressurizing the solder sheet and the substrate in an overlapping state; and
(B3) heating the pressurized solder sheet and substrate at a melting temperature of the plurality of solder rods, or higher.

13. The method as set forth in claim 12, further comprising:
(B4) applying a flux to the substrate, before step (B1).

14. The method as set forth in claim 7, wherein step (C) includes:
(C1) melting the plurality of solder rods of the heated solder sheet on the soldering portions of the substrate; and
(C2) cooling the melted solder rods to form solder bumps on the soldering portions.

15. The method as set forth in claim 7, further comprising:
(E) removing remaining solder bumps other than those formed on the soldering portions of the substrate, after step (D).

16. The method as set forth in claim 15, wherein, in step (E), any one of an air blowing process and a cleansing process is performed.
